(19) United States
(12) Patent Application Publication
(10) Pub. No.: US 2006/0227237 A1
(43) Pub. Date: Oct. 12, 2006

(54) Video surveillance system and method with combined video and audio recognition

(75) Inventors: Martin G. Kienzle, Briarcliff Manor, NY (US); Vadim Sheinin, Yorktown Heights, NY (US)

Correspondence Address: SCULLY SCOTT MURPHY & PRESSER, PC, 400 GARDEN CITY PLAZA, SUITE 300, GARDEN CITY, NY, 11530, US

(73) Assignee: INTERNATIONAL BUSINESS MACHINES CORPORATION, ARMONK, NY (US)

(21) Appl. No.: 11/094,953

(22) Filed: Mar. 31, 2005

(51) Int. Cl. G02B 27/10

(52) U.S. Cl. 348/343

(57) ABSTRACT

A novel video surveillance system is made up of video and audio compression engine, a storage device and, a video and audio recognition engine. The video recognition engine detects such events as face recognition, motion detection etc, whereas audio recognition engine detects voice and other sound signatures indicating a potential alarm situation, e.g., panic voices such as screaming and yelling, or sounds such as gun shots, explosions. Combined recognition of audio and video signals provides for higher true alarm generation and lower false alarms level of the surveillance system. Additionally, the audio recognition engine provides information for directing video cameras in the direction of interest allowing better capture of an interesting scene.

### BACKGROUND OF THE INVENTION

1. Field of the Invention

The present invention generally relates to surveillance systems and methods for providing security, and, more particularly to a novel on-line (real-time) video and audio recognition system and process for surveillance systems.

2. Description of the Prior Art

Conventional video surveillance systems typically do not include any functionality or provision for monitoring audio; i.e., surveillance systems do not include audio inputs at all. At best, typical video surveillance systems such as described in U.S. Pat. Nos. 6,724,421 and 6,175,382 provide simultaneous recording of visual and audio information. In both types of video surveillance systems described in these references, video data is being analyzed by smart surveillance engines and are compressed for digital storage. These engines implement various recognition algorithms such as face recognition, motion detection, panic detection, stabbing motion detection etc. One alarming situation, for example, when monitoring an entrance to a high-rise building, involves a sudden fast motion of one person towards another one, implying a potential robbery, battery, or similar activity. A smart surveillance engine in this case will recognize (with some level of success which is less than 100%) fast sudden motion and generate an alarm at the monitoring station. Police forces can be dispatched to the monitored location as a consequence of such an alarm. Obviously, fast sudden motion could have been generated by a child running towards his/her parent/friend and in this case the generated alarm becomes a false alarm which will cause an expensive dispatch of the police force. Another outcome of smart surveillance engine misdetection is an absence of alarm generation in case of a real emergency. This case may arise, for example, when there is more than one person at the scene. Not sending a police force when the true emergency situation is taking place is yet another drawback of current surveillance systems.

Prior art video-only surveillance system is depicted in FIG. 1. A camera array 10 feeds video information into a video compression engine 12 through video link 11. The video information is compressed and sent through link 16 to a storage device 14 for a long-term storing. Video information is additionally fed to video recognition engine 13 through the same video link 11. Video recognition engine 13 performs video recognition tasks, such as face recognition, motion detection and others, and generates events and alarms that are sent through link 17 to an events data base 15 and monitoring station 18. Monitoring station 18 may comprise a manned monitoring station whereby an operator performs real-time visual monitoring of a particular amount of cameras. When an emergency situation takes place, as interpreted by the operator, it is his/her decision whether or not to dispatch a police force or other emergency response team to the monitored area. It is clear from the above description that there is no use of audio information although such information is very often available at the monitored area.

Prior Art video surveillance system with audio recording is shown in FIG. 2. Camera array 20 feeds video information into video and audio compression engine 22 through video link 21. Simultaneously, audio information is fed from microphone array 29 through audio link 30 to the video and audio compression engine 22. The video and audio information is compressed and sent through link 26 to a storage device 24 for a long-term storing. Video information is similarly fed to the video recognition engine 23 through the same video link 21. Video recognition engine 23 performs video recognition tasks, such as face recognition, motion detection and others, and generates events and alarms that are sent through link 27 to a database 25 and monitoring station 28. Monitoring station 28 is a manned monitoring station whereby an operator performs visual monitoring of a particular amount of cameras. When an emergency situation takes place, as interpreted by the operator, it is his/her decision whether or not to dispatch a police force or other emergency response team to the monitored area. It is clear from the above description that there is no extraction of useful information from the audio inputs although such information is very often available in the audio signals obtained from at the monitored area.

As described above, a second type of surveillance system simultaneously records video and audio information as well as implements smart surveillance engines for various video recognition tasks. Today, in these systems, audio information is compressed and recorded without being analyzed.

Today's surveillance systems simply do not utilize rather precious audio information when analyzing video input. Obviously, this audio information is available and in many surveillance scenarios can be used very extensively.

Thus, it would be highly desirable to incorporate the use of audio information in video surveillance systems with the expectation that use of audio information will decrease the number of false alarms generated by surveillance system as well as increase the percentage of true alarms detected, while at the same time, providing more information to the person evaluating an alarm. Additionally, some events may be detected using audio and video information as opposed to such events being undetected using video information only.

### SUMMARY OF THE INVENTION

It is thus an object of the present invention to provide a video surveillance system and method that incorporates the use of video information coupled with audio information obtained from the area under surveillance.

The surveillance system of the invention includes both video and audio signal inputs. Video inputs are sourced from digital or analog cameras and audio inputs are received from microphones installed at a monitored area. Video and audio information is compressed and sent to a digital storage device. Compression of the audio and video information is preferred in order to save amount of digital storage required for all cameras and microphones implemented. Simultaneously with the recording, video and audio inputs are fed into a smart recognition engine that performs video recognition, audio recognition and performs instantaneous correlation of the results from video-audio recognition for detecting/recognizing a particular set of events, indicative of a panic situation, e.g., high-pitch screaming voices, explosion, gun shots, etc. Alarms generated by the smart recognition engine may be sent to a monitoring station where a human operator decides whether to dispatch a police or emergency personnel to a monitored area.

According to one aspect of the invention, the smart recognition engine executes available video recognition algorithms, such as face recognition, motion detection, etc., as well as audio/speech recognition algorithms for speech recognition of a particular vocabulary (“Help”, “Robbery”, etc.). The audio recognition engine may be trained to recognize special audio signals such as gun shots, explosions, etc. as well as high-pitch and other voice signatures indicative of an alarm or emergency situation.

Using arrays of microphones placed in particular orientations, directions of sounds can be determined. Directional audio information may then be delivered to a camera control unit for directing a camera/cameras in the direction of interest. Further video/audio recognition may then be performed with better efficiency. Thus, for example, an explosion sound may be detected by audio recognition engine using an array of microphones in a monitored area. As a consequence, cameras will be directed into explosion direction and follow-on actions will take place in the video recognition engine—from alarming the monitoring station up to scene recognition/understanding. The instantaneous use of results from video and audio recognition to direct the further evaluation of recorded audio and video, and to direct improved recording of new video and audio inputs, advantageously improves the accuracy of the detection, reduces the time it takes to determine the nature of an alarm, and provides more information to a human operator evaluating the situation.

Outputs from the video recognition engine and the audio recognition engine are analyzed by mutual recognition engine and as a consequence final alarms are generated and forwarded to the monitoring station.

In keeping with these and other objects, according to a preferred aspect of the invention, there is provided a surveillance system and method, and computer program product, wherein the system comprises:

a means for generating real-time video signals comprising video information taken over an area under surveillance;

a means for obtaining real-time audio signals comprising audio information from the area under surveillance;

a means for simultaneously receiving the video signals and audio signals, determining relevant video and audio recognition information therefrom, and mutually correlating the real-time audio and video information to determine likelihood of occurrence of a particular event; and,

a means for generating an alarm condition based on occurrence of the particular event.

### BRIEF DESCRIPTION OF THE DRAWINGS

Further features, aspects and advantages of the structures and methods of the present invention will become better understood with regard to the following description, appended claims, and accompanying drawings where:

FIG. 1 illustrates a video only surveillance system according to the prior art;

FIG. 2 illustrates a Video Surveillance System with Audio Recording capability according to the prior art;

FIG. 3 illustrates a Video Surveillance System with Video and Audio Recognition according to the invention; and,

FIG. 4 illustrates details of the Smart Recognition Engine according to the invention.

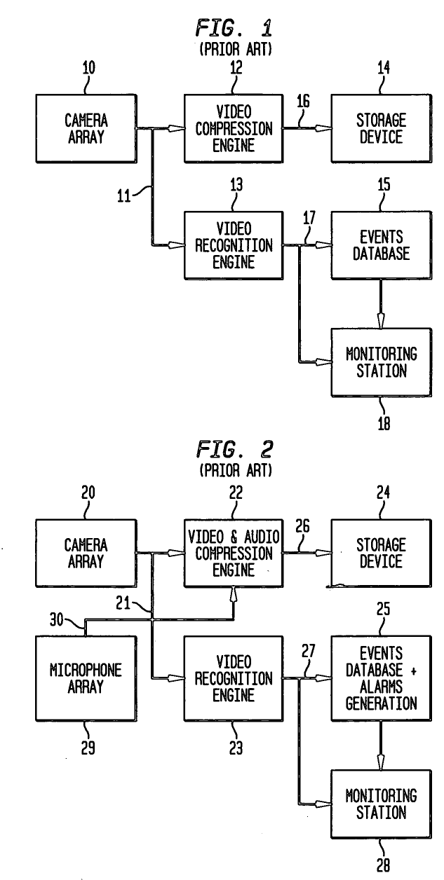

### DETAILED DESCRIPTION OF THE PREFERRED EMBODIMENTS

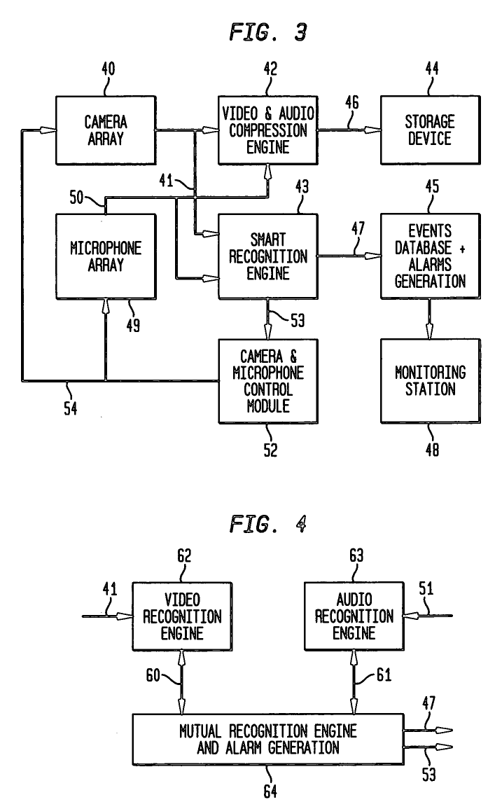

FIG. 3 illustrates a Video Surveillance System with video and audio recognition according to the invention. As shown in FIG. 3 a camera array 40 comprising one or more still or video electronic cameras, e.g., CCD or CMOS cameras, either color or monochrome or having an equivalent combination of components that capture an area under surveillance feeds video signals into a digital video and audio compression engine 42 through a video communications link 41. Motion and operation of each camera device of the camera array 40 may be controlled by received control signals, e.g., under computer and/or software control. Moreover, operational parameters for each camera in camera array 40 including pan/tilt mirror, lens system, focus motor, pan motor, and tilt motor control are controlled by received control signals, as will be explained in greater detail herein. Prior to outputting the digital video signals, many signal processing techniques may be applied for reducing noise or providing filtering/image enhancing techniques, for example.

Simultaneously, a microphone array 49 comprising microphone sensor devices (omni-directional and/or highly directional microphones) that can convert acoustic pressure into electrical signals are provided to feed audio information into the digital video and audio compression engine 42 through audio communications link 50. As known to skilled artisans, a directivity level of the microphone array varies with respect to sound frequencies so that the number of microphones and the distance between the microphones may be determined in consideration of a required frequency range capable in order to provide any given degree of directivity. The microphones implemented in the array may be controlled under software control, for example, to accomplish these ends and, include transducers configured to have a pick-up pattern that may be distinctly biased towards various frequency receptions, e.g., in the range of human speech, explosions, gun shots, etc. In this manner the microphone array is ensured to be receptive to respond to an acoustic event's soundfield with a high degree of accuracy. Further audio signal conditioning techniques may be applied for digitizing the analog audio signals obtained using an A/D converter, for example, and for providing gain control, reducing/filtering noise, for example. The digitized video and audio information is digitally compressed and sent through link 46 to a memory storage device 44 for a long-term storage, e.g., a database, a hard disk drive, magnetic or optical media including but not limited to: a CD-ROM, DVD, tape, platter, disk array, or the like. The output of each camera of the camera array 40 is stored in the storage medium in a compressed format, such as MPEG1, MPEG2, and the like. Furthermore, the output of each camera of the array may be stored in a particular location on the storage medium associated with that camera or, is stored with an indication to which camera each stored output corresponds.

As further shown in FIG. 3, the same video information and audio information is additionally simultaneously fed to a smart recognition engine 43 through respective video link 41 and audio link 50. It is understood that the communication links 41 and 50 between the respective camera array and audio microphone array and the video and audio compression engine 42 and smart recognition engine 43 may be hardwired, or wireless links may be employed. Moreover, it is within the scope of the present invention for these communication links to take the form of cable, satellite, RF and microwave transmission, fiber optics, and the like.

As will be described in greater detail herein, as further depicted in FIG. 4, the smart recognition engine 43 comprises a video recognition engine 62, audio recognition engine 63, a mutual recognition engine and an alarm generation module 64. The smart recognition engine 43 implements software for controlling a computer device to perform methods and processes for executing video recognition algorithms and face recognition algorithms. These may be executed with and in conjunction with motion detection algorithms (for example, the well-known patch correlation or tracking algorithms that tracks the individual points) to estimate the motion of features in the image stream), etc. The smart recognition engine 43 additionally implements software for controlling a computer device to perform methods and processes for executing audio recognition and speech recognition algorithms. Speech recognition algorithms implemented as computer readable instructions, data structures, program modules, etc. may be used for recognizing particular spoken words that may be potentially indicative of an emergency or alarm-worthy situation (“Help”, “Robbery”, etc.).

An audio recognition engine 63, comprising computer readable instructions, data structures, program modules or other data, may be trained to recognize special audio signals such as gun shots, explosions, etc., as well as high-pitch sounds, e.g., screams, shrieks, and other sound and voice signatures associated with known potential alarm provoking events. It is understood however, that the various recognition algorithms may be employed according to the invention, that do not require prior training.

The computing device(s) implemented includes a general purpose computer device such as a PC, device, laptop, mobile device, and the like, having components including, but not limited to a processing unit, a system memory, and a system bus that couples various system components including the system memory to the processing unit. The computer device implements these components for executing the smart recognition engine and audio recognition engine that are stored on a well-known computer-readable medium comprising any available media that can be accessed by the computer device including both removable, non-removable media, volatile, and nonvolatile media. The computer-readable recording may be centralized at one location or decentralized over computer systems connected via network, for example, and computer-readable recognition algorithms can be stored in the computer-readable recording medium and be executed in a decentralized manner.

Returning to FIG. 3, using the array of microphones 49 in particular orientations, directions of sounds are determinable. Directional information concerning a sensed audio event is delivered to camera microphone control module 52 through a wired or wireless communications link 53. The camera/microphone control module 52 includes all of the software necessary to implement motor position control for directing camera/cameras of array 40 and controlling the positions of the microphone array 49 in the direction of interest by means of control signals 54. For instance, the control signals may be input to camera array 40 to adjust or control camera pan/tilt mirrors, lens system(s), focus motor, pan motor, and tilt motor components and sub-systems. These control signals are additionally used to automatically direct the field of view seen by the cameras in order to obtain a better centered image or, more zoomed, focused or more resolved image with more information regarding the actual alarm or alarm event. In one non-limiting example, in response to audio recognition of a gun shot audio signal by the smart recognition engine, control signals may be generated that direct one or more cameras of the camera array to the scene to “look” in the direction of the gun-shot. If video camera array is directed at the location of a crime from audio recognition of the gun-shot, then the “crime event” recognition will be better off because more information about the gun-shot is available. Alternately, or in addition, these control signals may be generated are used to automatically adjust the orientation of the microphones and the distance between the microphones to better receive the accompanying audio information. The microphones orientation may be additionally adjusted in consideration of detecting audio signals of a required frequency range, or for providing any given degree of directivity. Thus, for example, one or more microphones may be redirected to “listen” from a particular direction in response to a video recognition event.

More specifically, as shown in FIG. 4, outputs from video recognition 62 engine and audio recognition engine 63 are analyzed by the mutual recognition engine 64 for processing the simultaneously received video and audio recognition information and ultimately determining whether an alarm condition exists. In this manner, alarms may be generated that are forwarded to the manned monitoring station 48 through communications link 47. That is, the recognition processes employed as computer readable instructions, data structures, program modules, etc. used in the mutual recognition engine 64 are generally based upon a pattern matching and/or hypotheses evaluation. During an evaluation phase, there is determined an estimate of the probabilities of various events. This may be accomplished by determining from the real-time video recognition information and audio signals to what extent a correlation exists between the respective recognized video scenes and accompanying recognized voice or audio signatures. In an example recognition event, for recognizing a stabbing motion, the video information is used for the purpose of trying to evaluate probabilities of various video scenes. If it is known that such scenes would be accompanied by high pitch voice (screaming etc) then detecting a high-pitch from the audio input will increase the probability of it being a result of a stabbing motion as captured in the video signals. An operator performs visual monitoring of a particular area surveyed by the camera array 40 and when an alarm indication is provided by the alarm generating unit takes place, it the operator's decision to dispatch or not to dispatch a police or emergency personnel to the monitored area. It is clear from the above description that there is an extraction of useful information from the audio inputs which is, being combined with video recognition events, improves the total operation of the surveillance system.

As further shown in FIG. 4, communications link 60 between video recognition engine 62 and mutual recognition engine 64 is bidirectional, as are the communications link 61 between audio recognition engine 63 and mutual recognition engine 64. Bi-directionality of links 60 and 61 allows mutual influence of video and audio recognition algorithms in the manner as described, which, as a consequence, gives better recognition level for video and audio as well as possibility to implement detection of particular events that were heretofore impossible to detect.

While the invention has been particularly shown and described with respect to illustrative and preformed embodiments thereof, it will be understood by those skilled in the art that the foregoing and other changes in form and details may be made therein without departing from the spirit and scope of the invention which should be limited only by the scope of the appended claims.

Having thus described our invention, what we claim as new, and desire to secure by Letters Patent is:

1. A surveillance system utilizing video and audio recognition comprising:
a means for generating real-time video signals comprising video information taken over an area under surveillance;
a means for obtaining real-time audio signals comprising audio information from said area under surveillance;
a means for simultaneously receiving said video signals and audio signals, determining relevant video and audio recognition information therefrom, and mutually correlating the real-time audio and video information to determine likelihood of occurrence of a particular event; and,
a means for generating an alarm condition based on occurrence of said particular event.

2. The system as claimed in claim 1, wherein said processing means comprises a first recognition engine for processing said video signals for determining said video recognition information.

3. The system as claimed in claim 2, wherein said processing means comprises a second recognition engine for processing said audio signals for determining said audio recognition information.

4. The system as claimed in claim 1, wherein said processing means comprises a mutual recognition means for correlating the audio and video recognition information and increase ability of detecting occurrence of a particular event.

5. The system as claimed in claim 4, wherein said means for generating real time video signals comprises one or more video camera devices, said mutual recognition means further comprising means for generating control signals for directing one or more cameras of the camera devices to capture video signals in the direction of the particular event in response to recognizing occurrence of that event based on said audio recognition of the event

6. The system as claimed in claim 5, wherein each of said video camera devices comprise one or more of pan/tilt mirrors, lens system, focus motor, pan motor, and tilt motor components responsive to said control signals for adjusting one or more of pan, tilt, zoom, rotation, dolly, translate control parameters of the video camera devices.

7. The system as claimed in claim 4, wherein said means for generating real time audio signals comprises one or more microphone devices, said mutual recognition means further comprising means for generating control signals to direct one or more microphones of the microphone devices to enable the capture of audio recognition information in the direction of the particular event in response to recognizing occurrence of a potential event based on said video recognition of the event.

8. The system as claimed in claim 7, wherein each of said microphone devices are responsive to said control signals to automatically adjust the orientation of the microphones in consideration of detecting audio signals of a required frequency range.

9. The system as claimed in claim 7, wherein each of said microphone devices are responsive to said control signals to automatically adjust the orientation of the microphones in consideration of receiving audio signals at any given degree of directivity.

10. The system as claimed in claim 1, further comprising means for storing said audio and video data.

11. The system as claimed in claim 10, further comprising means for compressing said audio and video data prior to storing it in said storage means.

12. A surveillance method utilizing video and audio recognition comprising the steps of:
simultaneously receiving at a processing means real-time video signals comprising video information taken over an area under surveillance and real-time audio signals comprising audio information from said area under surveillance,
determining relevant video recognition and audio recognition information from said received video and audio signals;
mutually correlating the real-time audio and video recognition information to determine likelihood of occurrence of a particular event; and,
generating an alarm condition based on occurrence of said particular event.

13. The surveillance method as claimed in claim 12, wherein said processing means comprises a first recognition engine implementing processing steps for determining said video recognition information from said video signals.

14. The surveillance method as claimed in claim 13, wherein said processing means comprises a second recognition engine implementing processing steps for determining said audio recognition information from said audio signals.

15. The surveillance method as claimed in claim 12, wherein said processing means comprises a mutual recognition means for correlating the audio and video recognition information and increasing ability of detecting occurrence of a particular event.

16. The surveillance method as claimed in claim 15, wherein concurrent with said receiving step, a step of obtaining said real-time video signals by one or more video camera devices, said mutual recognition means further comprising means for generating control signals adapted for directing one or more cameras of the camera devices to capture video signals in the direction of the particular event in response to recognizing potential occurrence of that event based on said audio recognition of the event.

17. The surveillance method as claimed in claim 16, wherein each of said one or more video camera devices comprise one or more of pan/tilt mirrors, lens system, focus motor, pan motor, and tilt motor components that are responsive to said control signals for adjusting one or more of pan, tilt, zoom, rotation, dolly, translate control parameters of the video camera devices.

18. The surveillance method as claimed in claim 15, wherein concurrent with said receiving step, a step of obtaining said real-time audio signals by one or more microphone devices, said mutual recognition means further comprising means for generating control signals adapted for directing one or more microphones of the microphone devices to capture audio signals in the direction of the particular event in response to recognizing potential occurrence of that event based on video recognition of the event.

19. The surveillance method as claimed in claim 18, wherein each of said microphone devices are responsive to said control signals to automatically adjust the orientation of the microphones in consideration of detecting audio signals of a required frequency range.

20. The surveillance method as claimed in claim 18, wherein each of said microphone devices are responsive to said control signals to automatically adjust the orientation of the microphones in consideration of receiving audio signals at any given degree of directivity.

21. The surveillance method as claimed in claim 12, further comprising the step of storing said audio and video data in a data storage device.

22. The surveillance method as claimed in claim 21, further comprising the step of: compressing audio and video data prior to said storing in said data storage device.

23. A program storage device readable by a machine, tangibly embodying a program of instructions executable by the machine to implement method steps for performing surveillance of an area using video and audio recognition, said method steps including the steps of:
simultaneously receiving at a processing means real-time video signals comprising video information taken over an area under surveillance and real-time audio signals comprising audio information from said area under surveillance,
determining relevant video recognition and audio recognition information from said received video and audio signals;
mutually correlating the real-time audio and video recognition information to determine likelihood of occurrence of a particular event; and,
generating an alarm condition based on occurrence of said particular event.

24. The program storage device readable by a machine as claimed in claim 23, wherein said processing means comprises: a first recognition engine implementing processing steps for determining said video recognition information from said video signals, and a second recognition engine implementing processing steps for determining said audio recognition information from said audio signals.

25. The program storage device readable by a machine as claimed in claim 24, wherein said processing means comprises a mutual recognition means for correlating the audio and video recognition information and increasing ability of detecting occurrence of a particular event.

26. The program storage device readable by a machine as claimed in claim 25, wherein concurrent with said receiving step, a step of obtaining said real-time video signals by one or more video camera devices, said mutual recognition means further comprising means for generating control signals adapted for directing one or more cameras of the camera devices to capture video signals in the direction of the particular event in response to recognizing potential occurrence of that event based on said audio recognition of the event.

27. The program storage device readable by a machine as claimed in claim 25, wherein concurrent with said receiving step, a step of obtaining said real-time audio signals by one or more microphone devices, said mutual recognition means further comprising means for generating control signals adapted for directing one or more microphones of the microphone devices to capture audio signals in the direction of the particular event in response to recognizing potential occurrence of that event based on video recognition of the event.
